(19) United States
(12) Patent Application Publication
(10) Pub. No.: US 2017/0340167 A1
(43) Pub. Date: Nov. 30, 2017

(54) COLLAPSIBLE BARBECUE GRILL

(71) Applicant: KIOSKY CHUNG, Taichung City (TW)

(72) Inventor: KIOSKY CHUNG, Taichung City (TW)

(21) Appl. No.: 15/168,206

(22) Filed: May 30, 2016

(51) Int. Cl. A47J 37/07; F24B 1/18

(52) U.S. Cl. CPC A47J 37/0704; F24B 1/18; A47J 2037/0777

(57) ABSTRACT

A collapsible barbecue grill contains: a body, a connection holder, a first fixing mount, and a second fixing mount. The body includes an accommodation chamber for accommodating charcoals, the connection holder includes four slots defined on two opposite peripheral sides thereof, respectively, each of the four slots is located proximate to each of four corners of the connection holder. The first and second fixing mounts are fitted with two ends of the connection holder, respectively, wherein each of the first fixing mount and the second fixing mount includes two coupling bolts, and each of the two coupling bolts is fitted with said each slot. The first fixing mount also includes a first support segment arranged on a top thereof, and the second fixing mount also includes a second support segment arranged on a top thereof, hence the first support segment and the second support segment support the body.

### BACKGROUND OF THE INVENTION

### Field of the Invention

The present invention relates to a collapsible barbecue grill which is connected and stored easily and quickly.

### Description of the Prior Art

A conventional barbecue grill is employed to grill foods, such as meat, vegetables, and fishes, etc.

To barbecue easily and healthily, the barbecue grill contains a drilling device and a gas supply device below the drilling device. However, many users like grilling food by way of charcoals, but the conventional barbecue grill is removable by unscrewing coupling bolts inconveniently, after barbecue.

The present invention has arisen to mitigate and/or obviate the afore-described disadvantages.

### SUMMARY OF THE INVENTION

The primary objective of the present invention is to provide a collapsible barbecue grill which is connected and is stored easily and quickly.

Another objective of the present invention is to provide a collapsible barbecue grill which is foldable for storage in a small size.

To obtain the above objectives, a collapsible barbecue provided by the present invention contains: a body, a connection holder, a first fixing mount, and a second fixing mount.

The body includes an accommodation chamber defined thereon so as to accommodate charcoals, the connection holder includes four slots defined on two opposite peripheral sides thereof, respectively, and each of the four slots is located proximate to each of four corners of the connection holder, the first fixing mount and the second fixing mount are fitted with two ends of the connection holder, respectively, wherein each of the first fixing mount and the second fixing mount includes two coupling bolts, and each of the two coupling bolts is fitted with said each slot, the first fixing mount also includes a first support segment arranged on a top thereof, and the second fixing mount also includes a second support segment arranged on a top thereof, such that the first support segment and the second support segment support the body.

Preferably, the body further includes a wide-diameter section arranged around an upper end of an outer wall thereof and includes a narrow-diameter section formed around a lower end of an outer wall thereof, such that between the wide-diameter section and the narrow-diameter section is defined a stepped rim so as to abut against the first support segment and the second support segment, thus the body is supported by the first fixing mount and the second fixing mount securely, when the first fixing mount and the second fixing mount are erected; and when the first fixing mount and the second fixing mount cover on the connection holder, the body is placed on the connection holder by using its top, wherein the accommodation chamber corresponds to the wide-diameter section so as to accommodate the first fixing mount, the second fixing mount, and the connection holder.

Preferably, the wide-diameter section of the body has two flexible retainers mounted on two ends thereof, respectively, so as to retain with the first support segment of the first fixing mount and the second support segment of the second fixing mount.

Preferably, the body further includes a grill mesh and a plurality of recesses defined on the wide-diameter section thereof, and the grill mesh has multiple locking hooks configured to hook with the plurality of recessed, individually.

### BRIEF DESCRIPTION OF THE DRAWINGS

FIG. 1 is a perspective view showing the exploded components of a collapsible barbecue grill according to a preferred embodiment of the present invention.

FIG. 2 is a perspective view showing the assembly of the collapsible barbecue grill according to the preferred embodiment of the present invention.

FIG. 3 is a perspective view showing the operation of the collapsible barbecue grill according to the preferred embodiment of the present invention.

FIG. 4 is another perspective view showing the operation of the collapsible barbecue grill according to the preferred embodiment of the present invention.

FIG. 5 is also another perspective view showing the operation of the collapsible barbecue grill according to the preferred embodiment of the present invention.

FIG. 6 is still another perspective view showing the operation of the collapsible barbecue grill according to the preferred embodiment of the present invention.

### DETAILED DESCRIPTION OF THE PREFERRED EMBODIMENTS

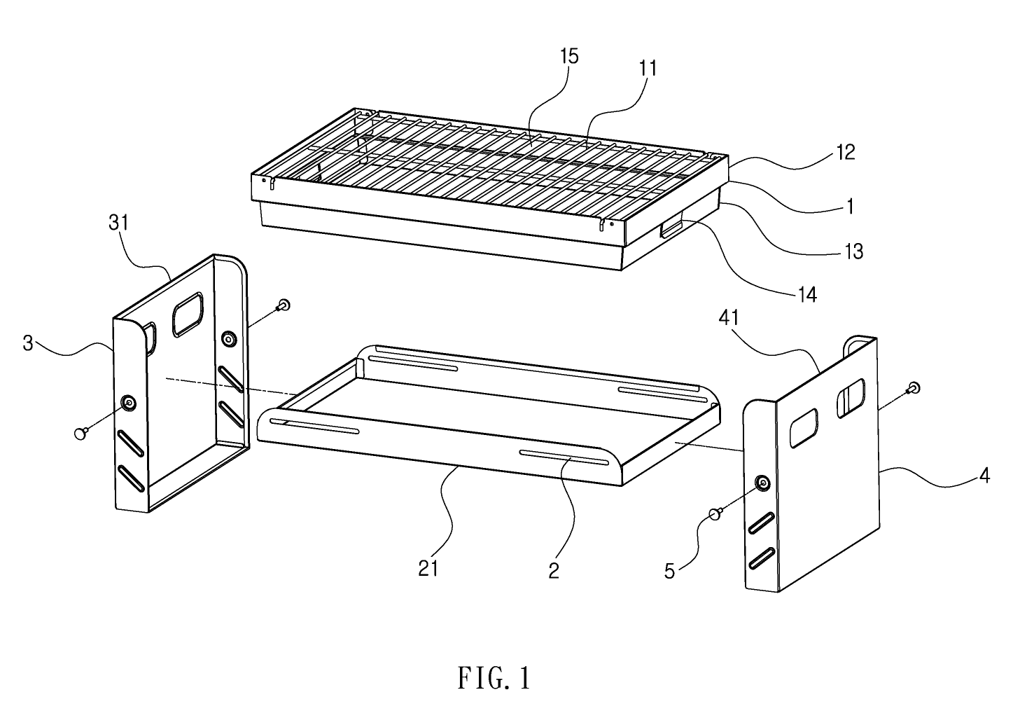

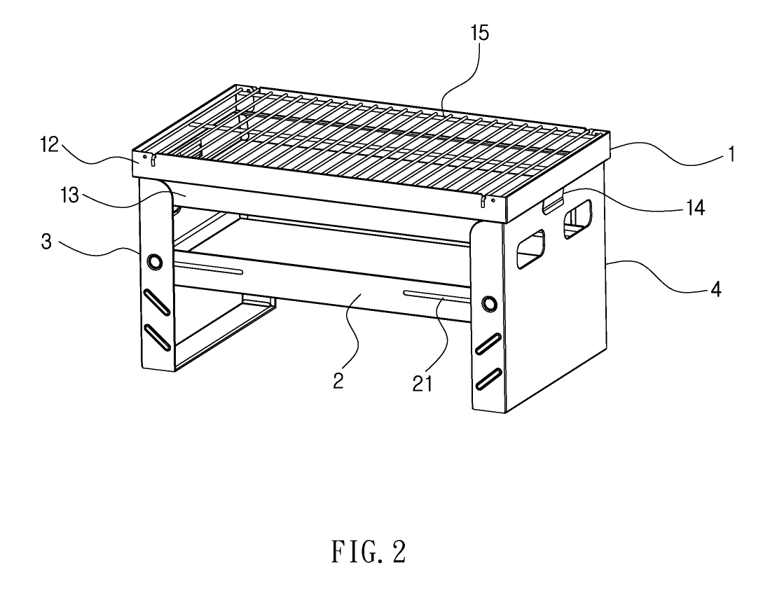

With reference to FIGS. 1 and 2, a collapsible barbecue grill according to a preferred embodiment of the present invention is foldable for storage in a small size. The collapsible barbecue grill comprises: a body 1, a connection holder 2, a first fixing mount 3, and a second fixing mount 4.

The body 1 includes an accommodation chamber 11 defined thereon so as to accommodate charcoals, the connection holder 2 includes four slots 21 defined on two opposite peripheral sides thereof, respectively, and each of the four slots 21 is located proximate to each of four corners of the connection holder 12. The first fixing mount 3 and the second fixing mount 4 are fitted with two ends of the connection holder 2, respectively, wherein each of the first fixing mount 3 and the second fixing mount 4 includes two coupling bolts 5, and each of the two coupling bolts 5 is fitted with said each slot 21, the first fixing mount 3 also includes a first support segment 31 arranged on a top thereof, and the second fixing mount 4 also includes a second support segment 41 arranged on a top thereof, such that the first support segment 31 and the second support segment 41 support the body 1.

In operation, the first fixing mount 3 and the second fixing mount 4 are perpendicular to the connection holder 2, and two inner walls of the first fixing mount 3 and the second fixing mount 4 are biased against the two ends of the connection holder 2, hence the body 1 is supported by the first support segment 31 of the first fixing mount 3 and the second support segment 41 of the second fixing mount 4.

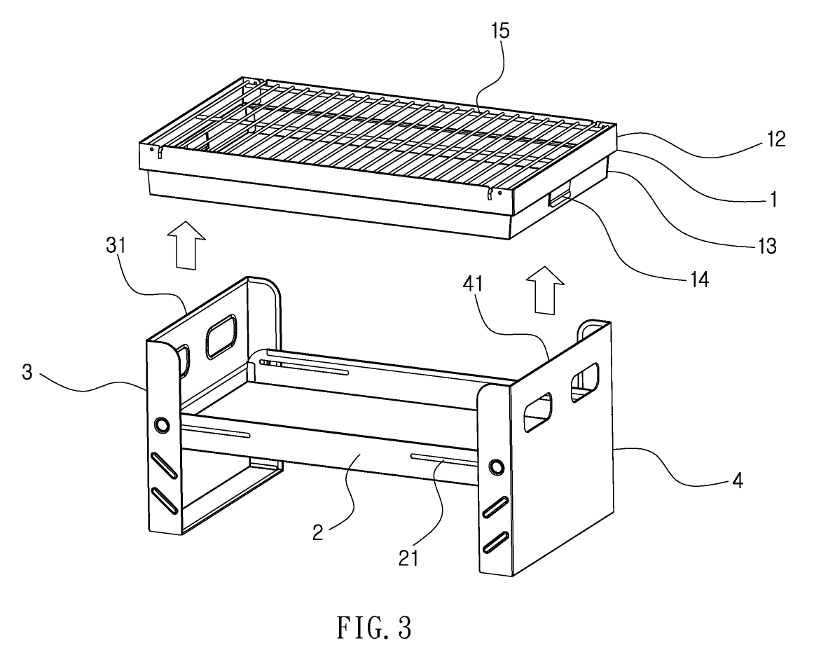

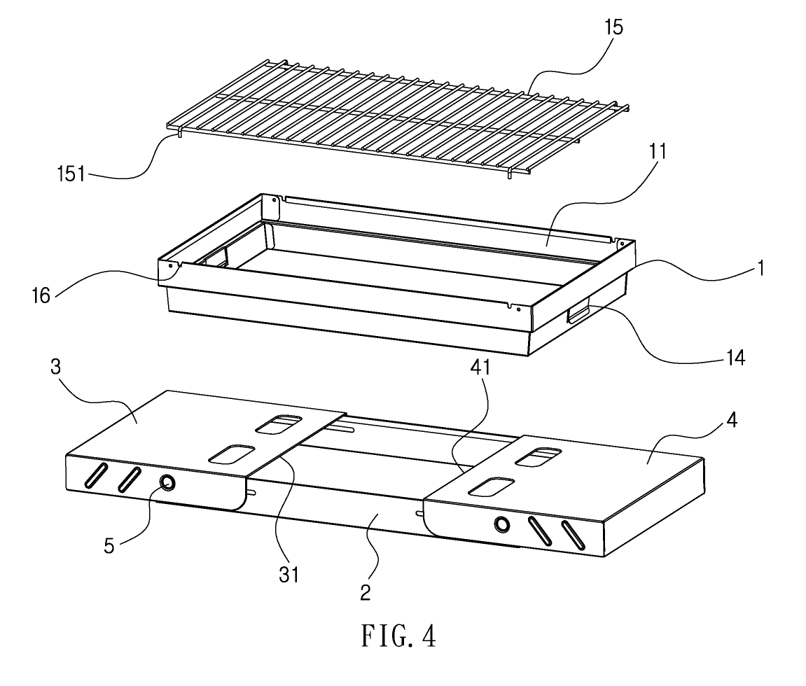

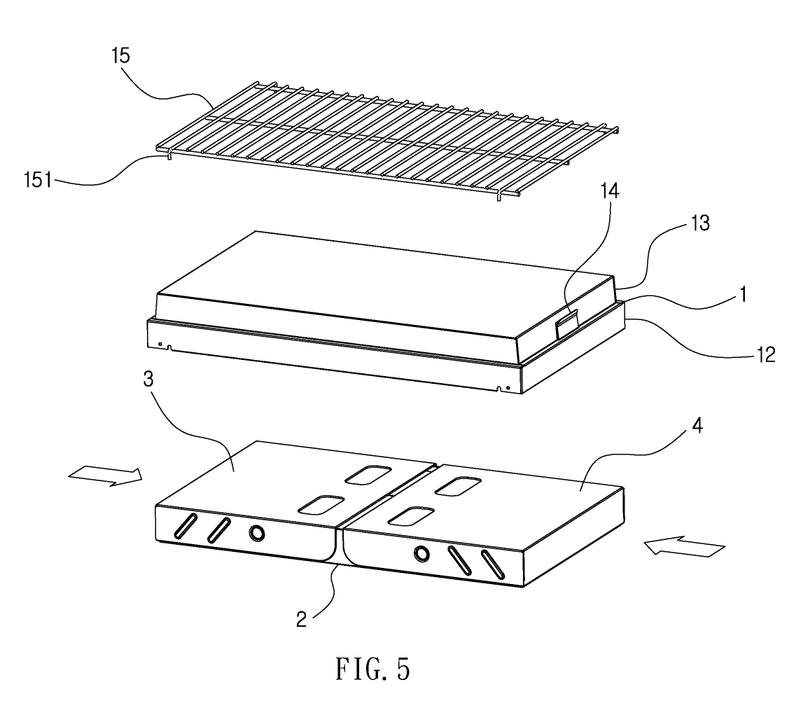

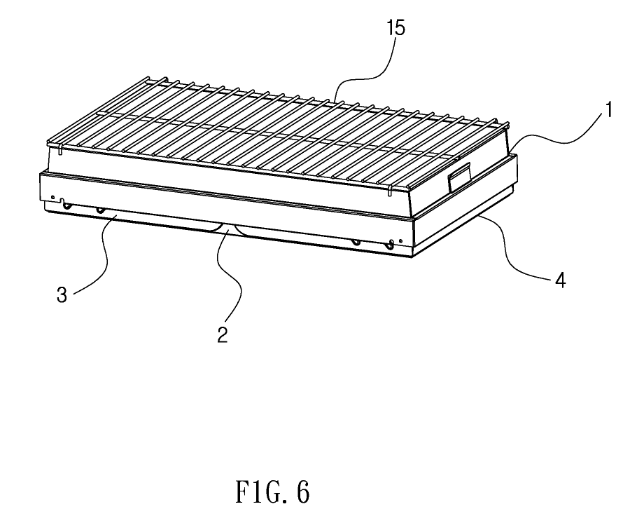

Referring further to FIGS. 3 to 6, the first support segment 31 of the first fixing mount 3 and the second support segment 41 of the second fixing mount 4 are removed from the body 1 (as shown in FIG. 3), and the first fixing mount 3 and the second fixing mount 4 are rotatably pressed downward so as to cover on a top of the connection holder 2 (as illustrated in FIG. 4), thereafter the first fixing mount 3 and the second fixing mount 4 are pushed inwardly along the top of the connection holder 2 (as shown in FIG. 5), and the body 1 is placed on the connection holder 2 (as illustrated in FIG. 6), thus storing the body 1, the connection holder 2, the first fixing mount 3, and the second fixing mount 4 together.

The body 1 further includes a wide-diameter section 12 arranged around an upper end of an outer wall thereof and includes a narrow-diameter section 13 formed around a lower end of an outer wall thereof, such that between the wide-diameter section 12 and the narrow-diameter section 13 is defined a stepped rim so as to abut against the first support segment 31 and the second support segment 41, thus the body 1 is supported by the first fixing mount 3 and the second fixing mount 4 securely.

When the first fixing mount 3 and the second fixing mount 4 cover on the connection holder 2, the body 1 is placed on the connection holder 2 by using its top (as shown in FIG. 5), and the accommodation chamber 11 corresponds to the wide-diameter section 12 so as to accommodate the first fixing mount 3, the second fixing mount 4, and the connection holder 2, thus decreasing storage size of the collapsible barbecue grill.

Furthermore, the wide-diameter section 12 of the body 1 has two flexible retainers 14 mounted on two ends thereof, respectively, so as to retain with the first support segment 31 and the second support segment 41, thus connecting the body 1, the first fixing mount 3, and the second fixing mount 4 stably.

The body 1 further includes a grill mesh 25 and a plurality of recesses 16 defined on the wide-diameter section 12 thereof, wherein the grill mesh 15 has multiple locking hooks 151 configured to hook with the plurality of recessed 16, individually.

Thereby, the collapsible barbecue grill is connected and is stored easily and quickly.

While the preferred embodiments of the invention have been set forth for the purpose of disclosure, modifications of the disclosed embodiments of the invention and other embodiments thereof may occur to those skilled in the art. Accordingly, the appended claims are intended to cover all embodiments which do not depart from the spirit and scope of the invention.

What is claimed is:

1. A collapsible barbecue grill comprising: a body, a connection holder, a first fixing mount, and a second fixing mount; wherein
the body includes an accommodation chamber defined thereon so as to accommodate charcoals, the connection holder includes four slots defined on two opposite peripheral sides thereof, respectively, and each of the four slots is located proximate to each of four corners of the connection holder, the first fixing mount and the second fixing mount are fitted with two ends of the connection holder, respectively, wherein each of the first fixing mount and the second fixing mount includes two coupling bolts, and each of the two coupling bolts is fitted with said each slot, the first fixing mount also includes a first support segment arranged on a top thereof, and the second fixing mount also includes a second support segment arranged on a top thereof, such that the first support segment and the second support segment support the body.

2. The collapsible barbecue grill as claimed in claim 1, wherein the body further includes a wide-diameter section arranged around an upper end of an outer wall thereof and includes a narrow-diameter section formed around a lower end of an outer wall thereof, such that between the wide-diameter section and the narrow-diameter section is defined a stepped rim so as to abut against the first support segment and the second support segment, thus the body is supported by the first fixing mount and the second fixing mount securely, when the first fixing mount and the second fixing mount are erected; and when the first fixing mount and the second fixing mount cover on the connection holder, the body is placed on the connection holder by using its top, and the accommodation chamber corresponds to the wide-diameter section so as to accommodate the first fixing mount, the second fixing mount, and the connection holder.

3. The collapsible barbecue grill as claimed in claim 2, wherein the wide-diameter section of the body has two flexible retainers mounted on two ends thereof, respectively, so as to retain with the first support segment of the first fixing mount and the second support segment of the second fixing mount.

4. The collapsible barbecue grill as claimed in claim 2, wherein the body further includes a grill mesh and a plurality of recesses defined on the wide-diameter section thereof, and the grill mesh has multiple locking hooks configured to hook with the plurality of recessed, individually.
